(19) United States
(12) Patent Application Publication
(10) Pub. No.: US 2025/0387824 A1
(43) Pub. Date: Dec. 25, 2025

(54) PROCESSING APPARATUS OF TRUNK LID HINGE ARM, PROCESSING METHOD OF TRUNK LID HINGE ARM, AND TRUNK LID HINGE ARM

(71) Applicants: HYUNDAI MOTOR COMPANY, SEOUL (KR); KIA CORPORATION, SEOUL (KR)

(72) Inventors: Mun Gu Kang, Hwaseong-si (KR); Jae Kwan Shim, Hwaseong-si (KR); Jaehyung Lee, Hwaseong-si (KR); Young Joo Kim, Hwaseong-si (KR)

(73) Assignees: HYUNDAI MOTOR COMPANY, SEOUL (KR); KIA CORPORATION, SEOUL (KR)

(21) Appl. No.: 18/921,575

(22) Filed: Oct. 21, 2024

(30) Foreign Application Priority Data
Jun. 20, 2024 (KR) 10-2024-0079965

(51) Int. Cl. B21D 35/00; B21D 9/12; B21D 53/40

(52) U.S. Cl. CPC B21D 35/005; B21D 9/12; B21D 53/40

(57) ABSTRACT

A processing apparatus of a trunk lid hinge arm includes a mandrel body extending in a longitudinal direction and configured to be insertable into an internal space of an extruded material, and a mandrel core fastened to a front end of the mandrel body, in which at least one surface of the mandrel core has a radius of curvature. The trunk lid hinge arm may comprise an aluminum alloy and comprise at least one bending part.

### CROSS REFERENCE TO RELATED APPLICATIONS

This present application claims the benefit of priority to Korean Patent Application No. 10-2024-0079965, filed on Jun. 20, 2024 in the Korean Intellectual Property Office, the entire disclosure of which is incorporated herein by reference.

### FIELD

The present disclosure relates to a processing apparatus of a trunk lid hinge arm, a processing method of a trunk lid hinge arm, and a trunk lid hinge arm.

### BACKGROUND

A trunk room of a passenger vehicle is a space at a rear of a vehicle where cargo is put, and is equipped with a trunk lid and is opened and closed.

A shape of the trunk lid varies depending on the design and shape classification of a vehicle, but the shape of the trunk lid of a typical sedan type vehicle may have a bent shape to shield upper and rear sides of the trunk room. The trunk lid is coupled to a vehicle body by a hinge device and is opened and closed by rotating the hinge.

The hinge device pops-up the trunk lid to a predetermined height when the trunk lid is opened and various auxiliary devices such as a hinge arm may be added to assist a lifting force.

When the trunk lid hinge arm comprises iron (Fe), there is a problem that it is disadvantageous in reducing a weight. When the trunk lid hinge arm comprises an aluminum material, the weight reduction may be satisfied, but dimensional dissatisfaction may occur due to excessive deformation during molding. In addition, there is a problem that quality deteriorates due to phenomena such as wrinkles or orange peel occurring on a surface of a bending area.

### SUMMARY

An aspect of the present disclosure is to provide a processing apparatus of a trunk lid hinge arm capable of manufacturing a trunk lid trunk hinge arm with improved quality, and a processing method for a trunk lid hinge arm. The present disclosure provides a trunk lid hinge arm with improved quality.

According to an aspect of the present disclosure, a processing apparatus of a trunk lid hinge arm comprises a mandrel body extending in a longitudinal direction and formed to be insertable into an internal space of an extruded material, and a mandrel core fastened to a front end of the mandrel body, in which at least one surface of the mandrel core may have a radius of curvature.

In a processing apparatus of a trunk lid hinge arm according to an aspect of the present disclosure, the mandrel core may comprise a molded surface corresponding to a front surface of the mandrel core, a side surface extending in the longitudinal direction of the mandrel core, and an edge surface between the molded surface and the side surface, and the molded surface and the edge surface may have the radius of curvature.

In a processing apparatus of a trunk lid hinge arm according to an aspect of the present disclosure, the radius of curvature (R value) of the molded surface may be 50R to 70R.

In a processing apparatus of a trunk lid hinge arm according to an aspect of the present disclosure, the radius of curvature (R value) of the edge surface may be 0.5R to 3R.

According to another aspect of the present disclosure, a processing method of a trunk lid hinge arm may comprise preparing aluminum extruded material, inserting a processing apparatus into an internal space of the extruded material; rotating the extruded material; and extracting the processing apparatus.

In a processing method of a trunk lid hinge arm according to an aspect of the present disclosure, the processing apparatus may comprise a mandrel body extending in a longitudinal direction and formed to be insertable into an internal space of an extruded material; and a mandrel core fastened to a front end of the mandrel body, and at least one surface of the mandrel core may have a radius of curvature.

In a processing method of a trunk lid hinge arm according to an aspect of the present disclosure, the mandrel core may comprise a molded surface corresponding to a front surface of the mandrel core, a side surface extending in the longitudinal direction of the mandrel core; and an edge surface between the molded surface and the side surface, and the molded surface and the edge surface may have the radius of curvature.

In a processing method of a trunk lid hinge arm according to an aspect of the present disclosure, the radius of curvature (R value) of the molded surface may be 50R to 70R.

In a processing method of a trunk lid hinge arm according to an aspect of the present disclosure, the radius of curvature (R value) of the edge surface may be 0.5R to 3R.

In a processing method of a trunk lid hinge arm according to an aspect of the present disclosure, the aluminum extruded material may comprise an Al—Mg—Si alloy.

In a processing method of a trunk lid hinge arm according to an aspect of the present disclosure, the aluminum extruded material may comprise, with respect to a total composition of the extruded material, 0.009 to 0.089 wt % of chromium (Cr), 0.030 to 0.043 wt % of copper (Cu), 0.24 to 0.29 wt % of iron (Fe), 0.47 to 0.55 wt % of magnesium (Mg), 0.039 to 0.10 wt % of manganese (Mn), 0.004 to 0.013 wt % of nickel (Ni), 0.40 to 0.55 wt % of silicon (Si), 0.010 to 0.021 wt % of titanium (Ti), 0.027 to 0.034 wt % of zinc (Zn), and the balance being aluminum (Al).

The processing method of a trunk lid hinge arm according to an aspect of the present disclosure may further comprise after extracting the processing apparatus, heat treating the extruded material.

The trunk lid hinge arm according to an aspect of the present disclosure may comprise an aluminum alloy and comprise at least one bending part.

In the trunk lid hinge arm according to an aspect of the present disclosure, an average size of grains of the aluminum alloy may be 80 μm to 120 μm.

In the trunk lid hinge arm according to an aspect of the present disclosure, the aluminum alloy may be an Al—Mg—Si alloy.

In the trunk lid hinge arm according to an aspect of the present disclosure, the aluminum alloy may comprise, with respect to a total composition of the aluminum alloy, 0.009 to 0.089 wt % of chromium (Cr), 0.030 to 0.043 wt % of copper (Cu), 0.24 to 0.29 wt % of iron (Fe), 0.47 to 0.55 wt % of magnesium (Mg), 0.039 to 0.10 wt % of manganese (Mn), 0.004 to 0.013 wt % of nickel (Ni), 0.40 to 0.55 wt % of silicon (Si), 0.010 to 0.021 wt % of titanium (Ti), 0.027 to 0.034 wt % of zinc (Zn), and the balance being aluminum (Al).

### BRIEF DESCRIPTION OF THE FIGURES

The above and other aspects, features, and advantages of the present disclosure will become apparent from the detailed description of the following aspects in conjunction with the accompanying drawings, in which:

FIG. 1 is a perspective view of a processing apparatus of a trunk lid hinge arm according to various embodiments of the present disclosure;

FIG. 2 is a perspective view of a mandrel core according to various embodiments of the present disclosure;

FIG. 3 is a cross-sectional view taken along line A-A′ in FIG. 2;

FIGS. 4A, 4B, 4C, and 4D are schematic diagrams for describing a processing method of a trunk lid hinge arm according to various embodiments of the present disclosure;

FIG. 5 is a perspective view of the trunk lid hinge arm manufactured by the processing method of a trunk lid hinge arm according to various embodiments of the present disclosure;

FIG. 6 is a cross-sectional view taken along line B-B′ in FIG. 5;

FIG. 7A is a diagram illustrating yield strength evaluation results of a trunk lid hinge arm manufactured according to Example 1 and Example 2;

FIG. 7B is a diagram illustrating tensile strength evaluation results of the trunk lid hinge arm manufactured according to Examples 1 and 2;

FIG. 7C is a diagram illustrating elongation evaluation results of the trunk lid hinge arm manufactured according to Examples 1 and 2;

FIG. 8A is a photograph of a V-bending angle evaluation device;

FIG. 8B is a diagram for describing a bending angle α;

FIG. 8C is a diagram for describing an extrusion direction and a bending direction of a specimen for evaluating the bending angle;

FIG. 9A is a surface photograph of a bending part in the trunk lid hinge arm manufactured according to Example 1;

FIG. 9B is a surface photograph of the bending part in the trunk lid hinge arm manufactured according to Example 2;

FIG. 10A is a diagram illustrating electron back scattered diffraction (EBSD) results of a base material of Example 1;

FIG. 10B is a diagram illustrating the EBSD results of the bending part of Example 1;

FIG. 10C is a diagram illustrating the EBSD results of the base material of Example 2;

FIG. 10D is a diagram illustrating the EBSD results of the bending part of Example 2;

FIG. 11A is a grain distribution of the base material of Example 1;

FIG. 11B is the grain distribution of the bending part of Example 1;

FIG. 11C is the grain distribution of the base material of Example 2; and

FIG. 11D is the grain distribution of the bending part of Example 2.

### DETAILED DESCRIPTION

Hereinafter, embodiments disclosed in the present specification will hereinafter be described in detail with reference to the accompanying drawings. In the following description, identical or similar components are given the same or similar reference numerals, and overlapping descriptions thereof may be omitted. Also, suffixes such as “module” or “unit” for used components do not have distinct meanings or roles in themselves.

Hereinafter, embodiments disclosed in the present specification will hereinafter be described in detail with reference to the accompanying drawings. In the following description, identical or similar components are given the same or similar reference numerals, and overlapping descriptions thereof may be omitted.

It is to be understood that when one component is referred to as being “connected to” or “coupled to” another component, one component may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween.

In this specification, terms such as “comprise” or “have” indicate the presence of features, numbers, steps, operations, components, parts, or combinations thereof described in the specification, but do not preclude any of the following: features, numbers, steps, operations, components, parts, or combinations thereof.

Various embodiments of the present disclosure relate to a processing apparatus for a trunk lid hinge arm. The trunk lid is a cover that opens and closes a trunk. Hinge arms bent on both sides may be connected to an inner surface of the trunk lid. The trunk lid hinge arm may pop-up the trunk lid to a predetermined height and may assist in lifting the trunk lid. The trunk lid hinge arm may comprise a bending molded portion at least in one portion. The processing apparatus of a trunk lid hinge arm according to various embodiments of the present disclosure may be a processing apparatus for such bending forming.

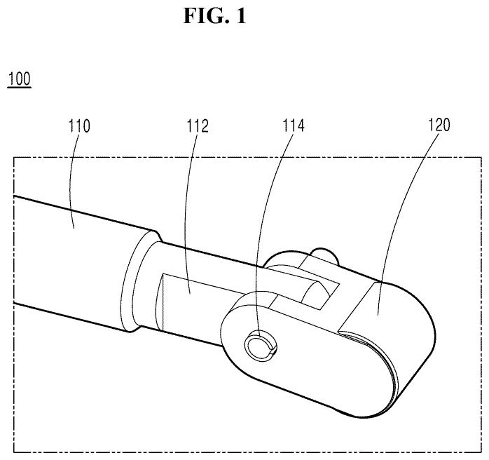

FIG. 1 is a perspective view of a processing apparatus of a trunk lid hinge arm according to various embodiments of the present disclosure.

Specifically, referring to FIG. 1, the processing apparatus 100 of the trunk lid hinge arm according to various embodiments of the present disclosure may comprise a mandrel body 110 and a mandrel core 120.

The mandrel body 110 may extend in a longitudinal direction and be inserted into an internal space of an extruded material of the trunk lid. For example, the extruded material of the trunk lid may be an aluminum extruded material, and the mandrel body 110 may be inserted into the internal space of the aluminum extruded material.

The mandrel core 120 may be fastened to a front end of the mandrel body 110. Specifically, the mandrel body 110 and the mandrel core 120 may be connected by a connection part 112. The mandrel body 110 and the mandrel core 120 may be coupled through a fastening part 114 and the connection part 112. For example, the fastening part 114 may have the same shape as a connection pin.

At least one surface of the mandrel core 120 may have a constant radius of curvature (R value).

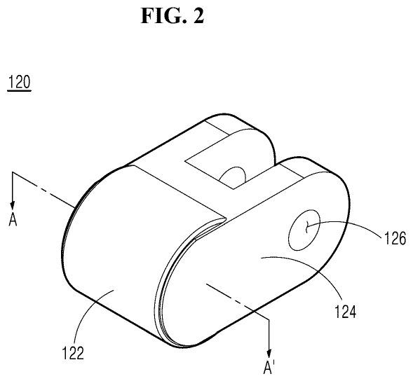

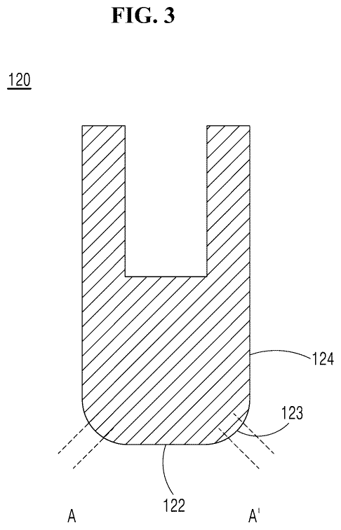

FIG. 2 is a perspective view of the mandrel core according to various embodiments of the present disclosure. FIG. 3 is a cross-sectional view taken along line A-A′ in FIG. 2.

Referring to FIGS. 2 and 3, the mandrel core 120 may comprise a molded surface 122, a side surface 124, and a fastening groove 126.

The fastening groove 126 may be formed on one surface of the side surface 124. The fastening groove 126 may be a groove into which the above-described described connection part 112 is inserted. By inserting the connecting portion 112 into the fastening groove 126, the mandrel body 110 and the mandrel core 120 may be coupled.

The molded surface 122 may be a portion located at the frontmost surface when the mandrel core 120 is inserted into the extruded material. The molded surface 122 may comprise a curved surface. The molded surface 122 may comprise a curved surface extending from a portion of the upper surface of the mandrel core 120 to a portion of the lower surface. The molded surface 122 may have a constant radius of curvature (R value). Specifically, the radius of curvature (R value) of the molded surface 122 may be 50R to 70R. Since the molded surface 122 has a specific radius of curvature, a bending part formed on the trunk lid hinge arm may be processed without deformation due to depression. In addition, the excessive deformation may be suppressed during processing the trunk lid hinge arm. Therefore, it is possible to prevent dimension dissatisfaction, depression, surface wrinkling or orange peel of the trunk lid hinge arm occurring by the excessive deformation. Preferably, the radius of curvature (R value) of the molded surface 122 may be 55R to 65R. More preferably, the radius of curvature (R value) of the molded surface 122 may be 60.5R.

The side surface 124 may be a surface other than the molded surface 122 of the mandrel core 120. The side surface 124 may be a surface that is in contact with the molded surface 122 but extends in the longitudinal direction. The side surface 124 may be a portion corresponding to the side surface of the mandrel core 120. The side surface 124 may have a flat surface.

The mandrel core 120 may comprise an edge surface 123 between the molded surface 122 and the side surface 124. The edge surface 123 may have a different radius of curvature (R value) from the molded surface 122. For example, the radius of curvature (R value) of the edge surface 123 may be 0.5R to 3R. Preferably, the radius of curvature (R value) of the edge surface 123 may be 1R to 2R. More preferably, the radius of curvature (R value) of the edge surface 123 may be 1R. Through this, the molded surface 122 and the side surface 124 may be smoothly connected.

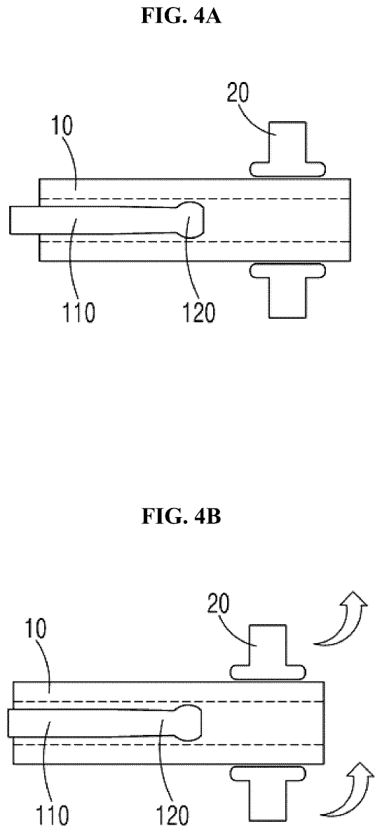

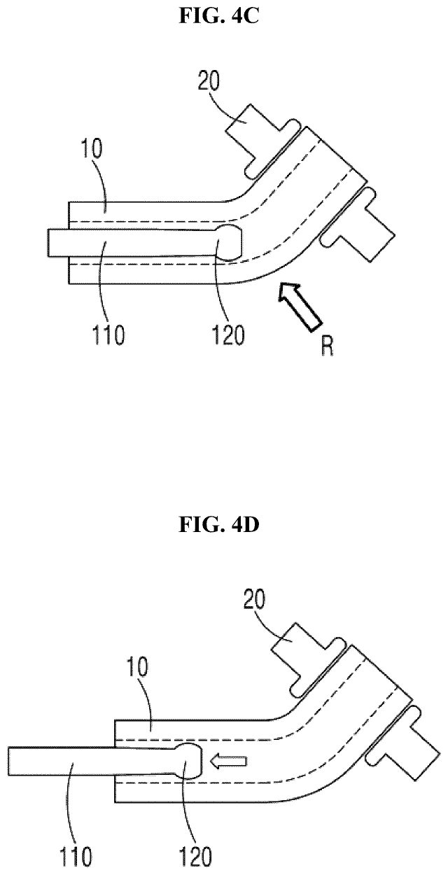

Hereinafter, the processing method of a trunk lid hinge arm driven by a processing unit according to various embodiments of the present disclosure will be described with reference to FIG. 4. The processing unit may be a variety of devices for forming a trunk lid hinge arm. The processing unit comprises the processing apparatus described above and a jig.

FIGS. 4A, 4B, 4C, and 4D are schematic diagrams for describing a processing method of a trunk lid hinge arm according to various embodiments of the present disclosure.

A processing method of a trunk lid hinge arm according to various embodiments of the present disclosure may comprise: preparing aluminum extruded material; inserting a processing apparatus into an internal space of the extruded material; rotating the extruded material; and extracting the processing apparatus.

In the preparing of the aluminum extruded material, the extruded material made of an aluminum material may be prepared. By including the aluminum material in the extruded material, it may be possible to reduce the weight of the finally manufactured trunk lid hinge arm. For example, the trunk lid hinge arm made of an aluminum material may be about 400 to 500 g lighter per piece compared to the existing Fe material.

The aluminum extruded material may be, for example, an Al—Mg—Si series alloy. More specifically, the aluminum extruded material may comprise chromium (Cr), copper (Cu), iron (Fc), magnesium (Mg), manganese (Mn), nickel (Ni), silicon (Si), titanium (Ti), zinc (Zn), and aluminum (Al). The aluminum extruded material may comprise, with respect to a total composition of the extruded material, 0.009 to 0.089 wt % of chromium (Cr), 0.030 to 0.043 wt % of copper (Cu), 0.24 to 0.29 wt % of iron (Fc), 0.47 to 0.55 wt % of magnesium (Mg), 0.039 to 0.10 wt % of manganese (Mn), 0.004 to 0.013 wt % of nickel (Ni), 0.40 to 0.55 wt % of silicon (Si), 0.010 to 0.021 wt % of titanium (Ti), 0.027 to 0.034 wt % of zinc (Zn), and the balance being aluminum (Al). More specifically, the aluminum extruded material may comprise, with respect to a total composition of the extruded material, 0.009 to 0.013 wt % of chromium (Cr), 0.030 to 0.034 wt % of copper (Cu), 0.25 to 0.29 wt % of iron (Fc), 0.47 to 0.51 wt % of magnesium (Mg), 0.039 to 0.043 wt % of manganese (Mn), 0.004 to 0.008 wt % of nickel (Ni), 0.40 to 0.44 wt % of silicon (Si), 0.010 to 0.014 wt % of titanium (Ti), 0.027 to 0.031 wt % of zinc (Zn), and the balance being aluminum (Al).

As the aluminum extruded material comprises the corresponding composition, the mechanical properties of the trunk lid hinge arm manufactured therefrom may be secured. For example, as the aluminum extruded material comprises the corresponding composition, the yield strength, tensile strength, elongation, and formability of the trunk lid hinge arm manufactured therefrom may be improved. For example, when the trunk lid hinge arm manufactured from the aluminum extruded material of the corresponding composition is subjected to additional heat treatment, the yield strength may be 200 MPa or more, the tensile strength may be 240 MPa or more, and the elongation may be 11% or more.

Meanwhile, referring to FIG. 4A, the processing method of a trunk lid hinge arm according to various embodiments of the present disclosure may comprise inserting the processing apparatus into the internal space of the extruded material 10. That is, the processing apparatus including the mandrel body 110 and the mandrel core 120 described above may be inserted into the internal space of the extruded material 10. In this case, the extruded material 10 may be fixed with a jig 20. By inserting the processing apparatus including the mandrel body 110 and the mandrel core 120 into the internal space of the extruded material 10, the finally manufactured trunk lid hinge arm may have a hollow shape whose inside is empty.

Next, referring to FIG. 4B and FIG. 4C, the processing method of a trunk lid hinge arm according to various embodiments of the present disclosure may comprise rotating the extruded material 10. Specifically, the extruded material 10 may be bending molded while rotating the jig 20 that fixes the extruded material 10. Therefore, referring to FIG. 4C, a constant curvature (R) may be formed in the extruded material 10.

Next, referring to FIG. 4D, the processing apparatus including the mandrel body 110 and the mandrel core 120 may be extracted while slowly moving backward. Through this, the bending molded trunk lid hinge arm may be manufactured.

The processing method of a trunk lid hinge arm according to various embodiments of the present disclosure may suppress the excessive deformation during the bending by using the mandrel core 120 having a specific curvature. Therefore, it is possible to prevent dimension dissatisfaction, depression, surface wrinkling or orange peel of the trunk lid hinge arm occurring by the excessive deformation.

Meanwhile, although not illustrated in the drawings, the processing method of a trunk lid hinge arm according to various embodiments of the present disclosure may further comprise performing heat treating the extruded material after extracting the processing apparatus. The processing method of a trunk lid hinge arm according to various embodiments of the present disclosure may further comprise performing heat treating on the trunk lid hinge arm after the molding the trunk lid hinge arm. For example, the heat treating may be performed at a temperature of 160° C. to 200° C. for 6 to 10 hours. Through the heat treating, it may be possible to improve the yield strength, tensile strength, and elongation of the trunk lid hinge arm.

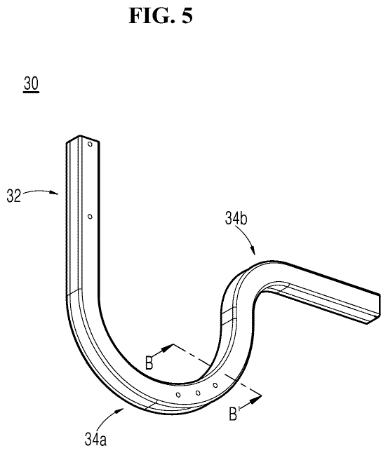

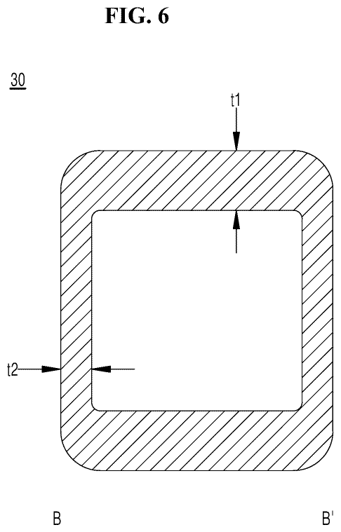

FIG. 5 is a perspective view of the trunk lid hinge arm manufactured by the processing method of a trunk lid hinge arm according to various embodiments of the present disclosure. FIG. 6 is a cross-sectional view taken along line B-B′ in FIG. 5.

Referring to FIG. 5, the trunk lid hinge arm 30 may comprise a base material 32 and bending parts 34a and 34b.

The base material 32 may be a portion of the trunk lid hinge arm 30 that does not undergo the bending molding. The base material 32 may be a straight portion of the trunk lid hinge arm 30.

The bending parts 34a and 34b may comprise a curved shape bent from the base material 32. The bending parts 34a and 34b may have a shape that prevents wrinkles or orange peel from occurring on the surface. The bending parts 34a and 34b may comprise two portions as illustrated in the drawing.

The trunk lid hinge arm 30 may comprise aluminum. Since the trunk lid hinge arm 30 comprises an aluminum alloy, it is possible to reduce the weight. For example, the trunk lid hinge arm 30 made of an aluminum material may be about 400 g to 500 g lighter per piece compared to the existing Fe material.

The aluminum alloy may be, for example, an Al—Mg—Si series alloy. More specifically, the aluminum alloy may comprise chromium (Cr), copper (Cu), iron (Fe), magnesium (Mg), manganese (Mn), nickel (Ni), silicon (Si), titanium (Ti), zinc (Zn), and aluminum (Al). The aluminum alloy may comprise, with respect to a total composition of the aluminum alloy, 0.009 to 0.089 wt % of chromium (Cr), 0.030 to 0.043 wt % of copper (Cu), 0.24 to 0.29 wt % of iron (Fe), 0.47 to 0.55 wt % of magnesium (Mg), 0.039 to 0.10 wt % of manganese (Mn), 0.004 to 0.013 wt % of nickel (Ni), 0.40 to 0.55 wt % of silicon (Si), 0.010 to 0.021 wt % of titanium (Ti), 0.027 to 0.034 wt % of zinc (Zn), and the balance being aluminum (Al). More specifically, the aluminum alloy may comprise, with respect to a total composition of the aluminum alloy, 0.009 to 0.013 wt % of chromium (Cr), 0.030 to 0.034 wt % of copper (Cu), 0.25 to 0.29 wt % of iron (Fe), 0.47 to 0.51 wt % of magnesium (Mg), 0.039 to 0.043 wt % of manganese (Mn), 0.004 to 0.008 wt % of nickel (Ni), 0.40 to 0.44 wt % of silicon (Si), 0.010 to 0.014 wt % of titanium (Ti), 0.027 to 0.031 wt % of zinc (Zn), and the balance being aluminum (Al).

The trunk lid hinge arm 30 may secure mechanical properties by including the aluminum alloy of the corresponding composition. For example, the trunk lid hinge arm may have improved yield strength, tensile strength, elongation, and formability. For example, the trunk lid hinge arm 30 may have a yield strength of 200 MPa or more, a tensile strength of 240 MPa or more, and an elongation of 11% or more.

An average size of grains of the aluminum material comprised in the base material 32 and the bending parts 34a and 34b may be 80 μm to 120 μm. Preferably, the average size of the grains of the aluminum material comprised in the base material 32 and the bending parts 34a and 34b may be 89 μm to 109 μm. By allowing the base material 32 and the bending parts 34a and 34b to have the corresponding grain size, it is possible to prevent the wrinkles or orange peel from occurring on the surface of the bending parts 34a and 34b.

The microstructures of the materials comprised in the base material 32 and the bending parts 34a and 34b may be different. Specifically, the grain size of the aluminum material comprised in the base material 32 and the bending parts 34a and 34b may be different. For example, the average size of the grains comprised in the base material 32 may be 100 μm to 120 μm. Preferably, the average size of the grains comprised in the base material 32 may be 105 μm to 109 μm. The average size of the grains of the aluminum material comprised in the bending parts 34a and 34b may be 80 μm to 100 μm. Preferably, the average size of the grains of the aluminum material comprised in the bending parts 34a and 34b may be 89 μm to 93 μm. By allowing the base material 32 and the bending parts 34a and 34b to have the corresponding grain size, it is possible to prevent the wrinkles or orange peel from occurring in the bending parts 34a and 34b.

The trunk lid hinge arm 30 may have a hollow shape whose inside is empty. Therefore, as illustrated in FIG. 6, a cross section of the trunk lid hinge arm 30 may comprise a rectangular empty space.

The trunk lid hinge arm 30 may have different thicknesses. For example, the trunk lid hinge arm 30 may have a first thickness t1 and a second thickness t2. Hereinafter, the first thickness t1 is referred to as a vertical thickness of the trunk lid hinge arm 30. The first thickness t1 may be 6.0 mm to 8.0 mm. Hereinafter, the second thickness t2 is referred to as a horizontal thickness of the trunk lid hinge arm 30. The second thickness t2 may be 1.5 mm to 3.5 mm. The trunk lid hinge arm 30 may secure the mechanical properties by having the thickness of the corresponding value.

Hereinafter, the present disclosure will be described in more detail through Examples. However, the following examples and experimental examples are only for illustrating the present disclosure in more detail, and the scope of the present disclosure is not limited by the following examples and experimental examples.

### Example 1

Bending molding of an extruded material was performed using an aluminum extruded material made of A6063 material with compositions shown in Table 1 below, and a mandrel core with a radius of curvature (R value) of a molded surface of 60.5R.

TABLE 1

| Material | | | | | | | | | | |
|---|---|---|---|---|---|---|---|---|---|---|
| Name | Cr | Cu | Fe | Mg | Mn | Ni | Si | Ti | Zn | Al |
| A6063 | 0.011 | 0.032 | 0.27 | 0.49 | 0.041 | 0.006 | 0.42 | 0.012 | 0.029 | Rem. |

### Example 2

Bending molding of an extruded material was performed using an aluminum extruded material made of A6N01 material with compositions shown in Table 2 below, and a mandrel core with a radius of curvature (R value) of a molded surface of 60.5R.

TABLE 2

| Material | | | | | | | | | | |
|---|---|---|---|---|---|---|---|---|---|---|
| Name | Cr | Cu | Fe | Mg | Mn | Ni | Si | Ti | Zn | Al |
| A6N01 | 0.087 | 0.041 | 0.26 | 0.53 | 0.098 | 0.011 | 0.53 | 0.019 | 0.032 | Rem. |

### Experimental Example: Tensile Evaluation

Yield strength, tensile strength, and elongation of a trunk lid hinge arm manufactured according to Examples 1 and 2 were evaluated. The yield strength, tensile strength, and elongation were measured according to KS B 0802.

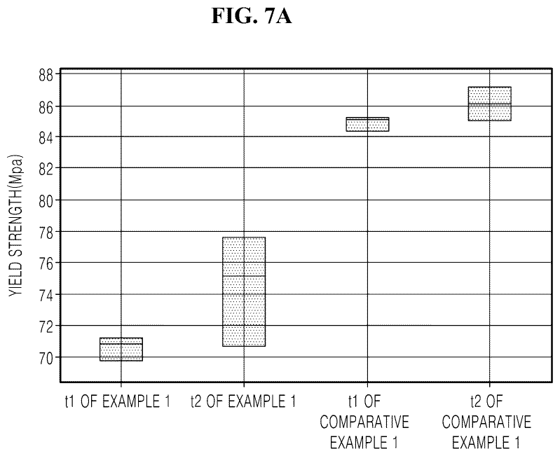

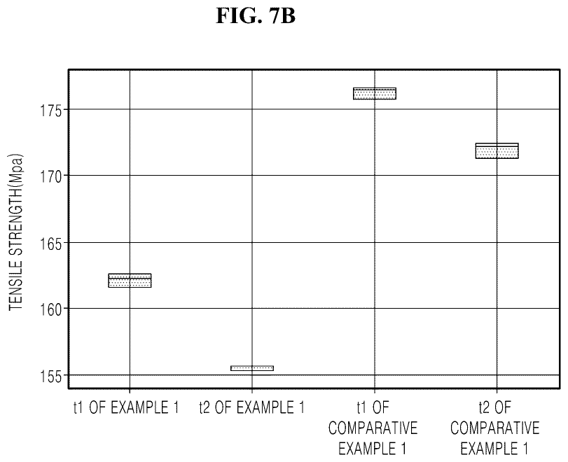

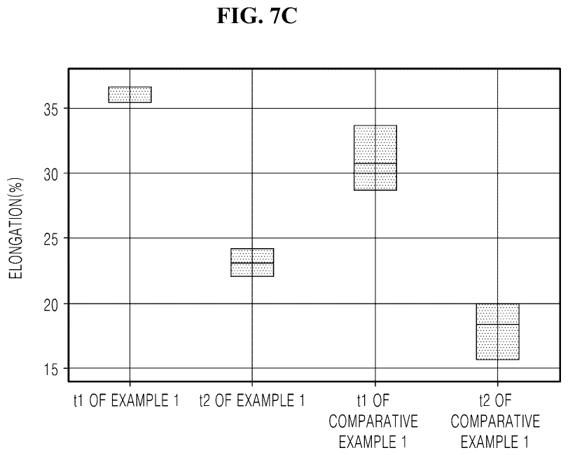

The evaluation results are shown in Table 3 below and FIGS. 7A to 7C. FIG. 7A is a diagram illustrating the yield strength evaluation results of the trunk lid hinge arm manufactured according to Example 1 and Example 2. FIG. 7B is a diagram illustrating the tensile strength evaluation results of the trunk lid hinge arm manufactured according to Examples 1 and 2. FIG. 7C is a diagram illustrating the elongation evaluation results of the trunk lid hinge arm manufactured according to Examples 1 and 2.

TABLE 3

| | | | Tensile Evaluation | | |
|---|---|---|---|---|---|
| | | | Yield | Tensile | |
| | | | Strength | Strength | Elongation |
| Division | Thickness (mm) | | (MPa) | (MPa) | (%) |
| Example 1 | Vertical | 7.00 | 71.3 | 162.4 | 35.1 |
| | Thickness | 7.00 | 69.5 | 161.4 | 36.7 |
| | (t1) | 7.00 | 70.7 | 162.2 | 36.7 |
| | | 7.00 | 71.0 | 162.7 | 36.6 |
| | | Average | 70.6 | 162.2 | 36.3 |
| | Horizontal | 2.59 | 70.7 | 155.4 | 22.1 |
| | Thickness | 2.56 | 75.2 | 155.6 | 23.1 |
| | (t2) | 2.56 | 77.6 | 155.4 | 24.2 |
| | | Average | 73.5 | 157.1 | 26.4 |
| Example 2 | Vertical | 7.00 | 84.9 | 176.6 | 34.2 |
| | Thickness | 7.00 | 85.2 | 176.4 | 28.6 |
| | (t1) | 7.00 | 84.2 | 175.6 | 32.3 |
| | | 7.00 | 85.2 | 176.6 | 29.1 |
| | | Average | 84.9 | 176.3 | 31.1 |
| | Horizontal | 2.59 | 85.1 | 172.2 | 20.0 |
| | Thickness | 2.56 | 87.2 | 172.5 | 20.0 |
| | (t2) | 2.56 | 85.0 | 171.0 | 15.3 |
| | | 2.56 | 87.0 | 172.2 | 16.7 |
| | | Average | 86.1 | 172.0 | 18.0 |

Referring to Table 3 and FIG. 7A, the yield strength of Example 2 was higher than that of Example 1. In addition, referring to Table 3 and FIG. 7B, the tensile strength of Example 2 was higher than that of Example 1. Referring to Table 3 and FIG. 7C, the elongation of Example 1 was higher than that of Example 2, but this did not appear to be a significant difference.

### Experimental Example 2: Bending Evaluation

V-bending angle evaluation, which is one of the formability evaluations, was performed on a trunk lid hinge arm manufactured according to Example 1 and Example 2. By evaluating the bending angle, deformability between materials may be compared.

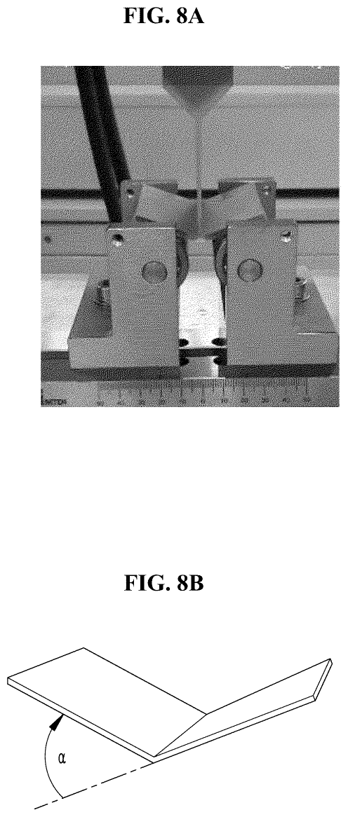

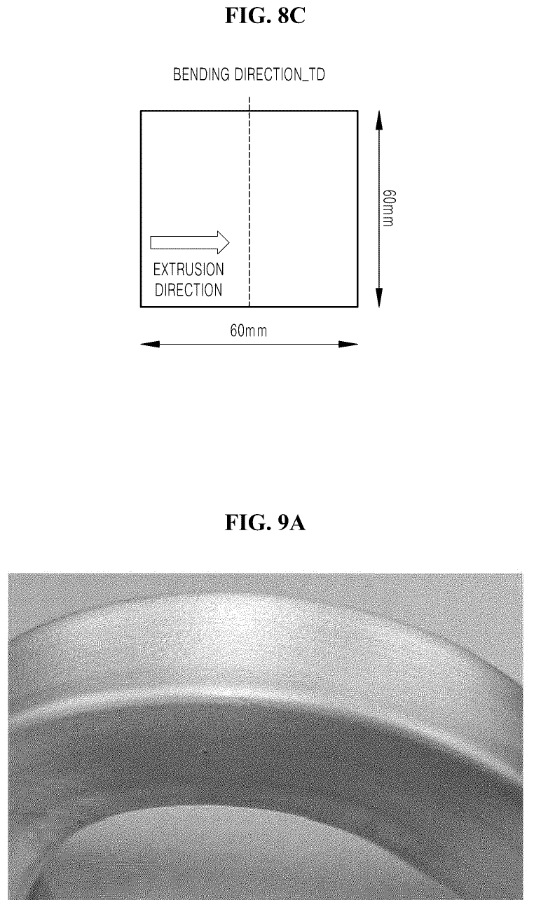

Meanwhile, during the evaluation, the evaluation device illustrated in FIG. 8A was used, and the bending angle α was confirmed as illustrated in FIG. 8B. In this case, the portions forming the horizontal and vertical thicknesses of the trunk lid hinge arm manufactured according to Examples 1 and 2 were prepared in the size illustrated in FIG. 8C for evaluation. That is, a specimen with a size of 60 mm×60 mm was prepared, and the direction (transverse direction, TD) perpendicular to the extrusion direction was set as the bending direction for evaluation.

The evaluation results are as shown in Table 4 below.

TABLE 4

| Division | Thickness (mm) | | Bending Angle (°) |
|---|---|---|---|
| Example 1 | Vertical Thickness | 7.00 | 110 |
| | (t1) | 7.00 | 111 |
| | | 7.00 | 112 |
| | | Average | 111 |
| | Horizontal Thickness | 2.54 | 128 |
| | (t2) | 2.54 | 127 |
| | | Average | 127 |
| Example 2 | Vertical Thickness | 7.00 | 108 |
| | (t1) | 7.00 | 110 |
| | | 7.00 | 110 |
| | | Average | 109 |
| | Horizontal Thickness | 2.49 | 132 |
| | (t2) | 2.49 | 131 |
| | | 2.49 | 134 |
| | | 2.49 | 128 |
| | | Average | 131 |

Referring to Table 4, in Example 1, the V-bending angle of the vertical thickness t1 showed an average of 111°, and the V-bending angle of the horizontal thickness t2 showed an average of 127°. In Example 2, the V-bending angle of the vertical thickness t1 showed an average of 109°, and the V-bending angle of the horizontal thickness t2 showed an average of 131°. In other words, it may be seen that the bending angle and deformability according to the material difference between Example 1 and Example 2 are similar.

### Experimental Example 3: Observation of Bending Part

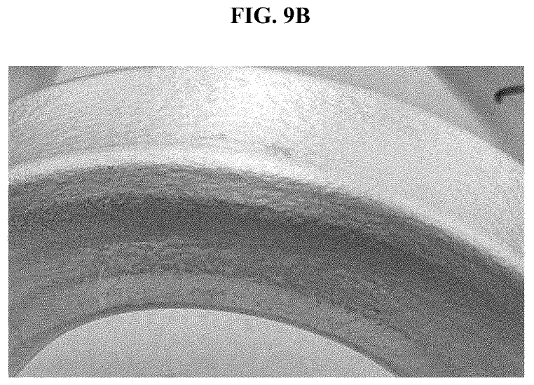

The surface of the bending part of the trunk lid hinge arm manufactured according to Example 1 and Example 2 was observed. FIG. 9A is a surface photograph of the bending part in the trunk lid hinge arm manufactured according to Example 1. FIG. 9B is a surface photograph of the bending part in the trunk lid hinge arm manufactured according to Example 2.

Referring to FIG. 9A, it may be seen that no wrinkles or orange peel occurred on the surface of the bending part in the trunk lid hinge arm manufactured according to Example 1. On the other hand, referring to FIG. 9B, it may be clearly seen that the wrinkles or orange peel occurred on the surface of the bending part in the trunk lid hinge arm manufactured according to Example 2.

From the above results, it may be seen that Example 2 had the bending angle similar to Example 1 and had physical properties of yield strength and tensile strength higher than Example 1, but the wrinkles or orange peel occurred on the surface of the bending part. Therefore, it was expected that the wrinkles or orange peel phenomenon on the surface of the bending part is influenced by microstructure rather than mechanical properties, and the experiment of Experimental Example 4 below was performed.

### Experimental Example 4: Observation of EBSD Microstructure and Grain Distribution

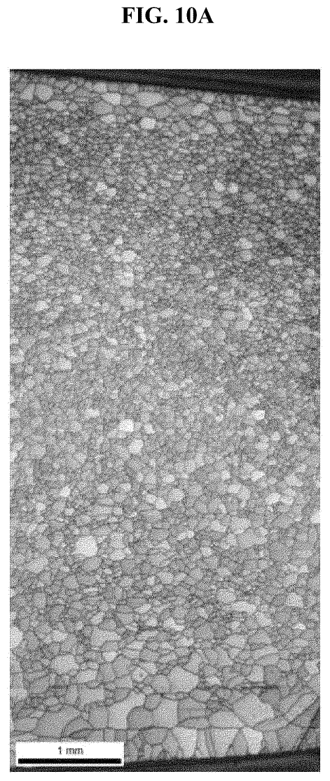

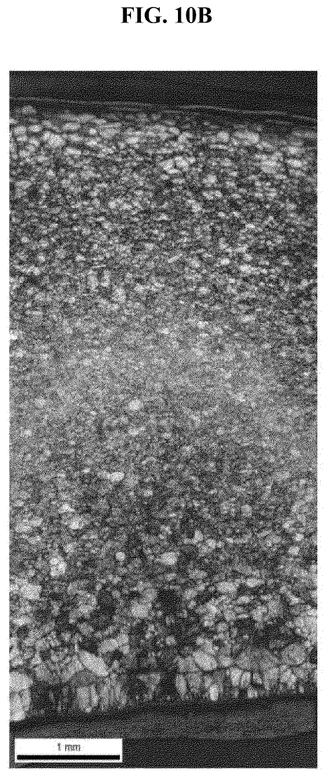

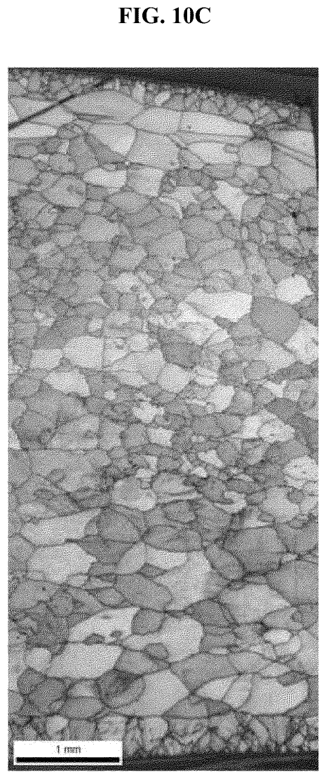

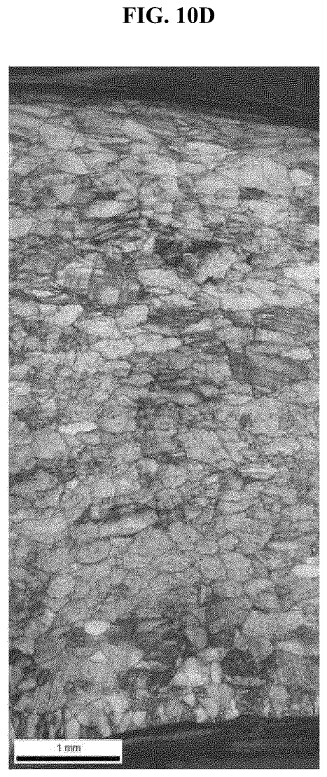

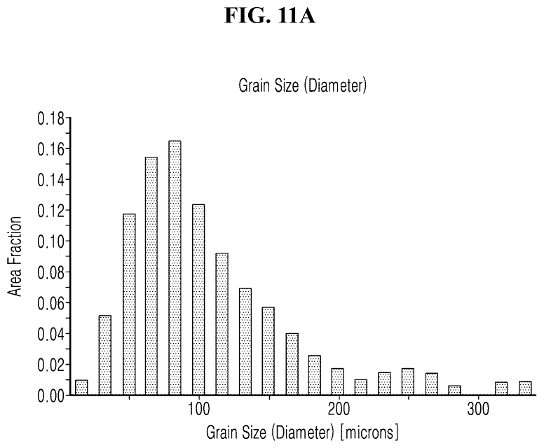

To observe the microstructure of Examples 1 and 2, the electron back scattered diffraction (EBSD) analysis was performed. FIG. 10A illustrates the EBSD results of the base material of Example 1. FIG. 10B is a diagram illustrating the EBSD results of the bending part of Example 1. FIG. 10C is a diagram illustrating the EBSD results of the base material of Example 2. FIG. 10D is a diagram illustrating the EBSD results of the bending part of Example 2.

Referring to FIGS. 10A to 10D, it may be seen that the grain size of Example 2 is larger than that of Example 1, regardless of the base material and bending part.

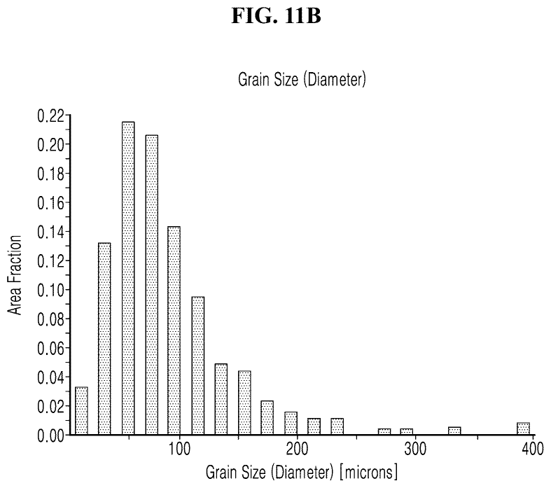

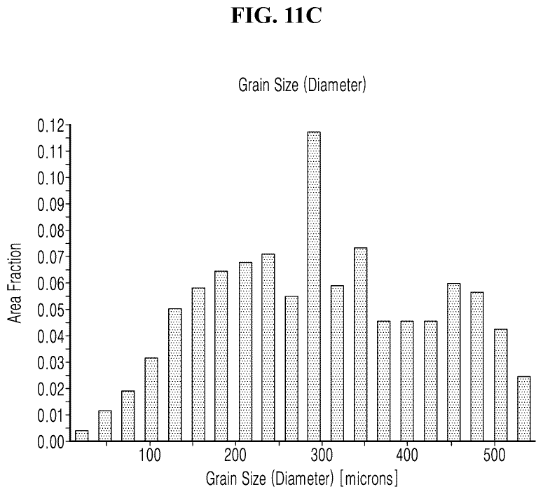

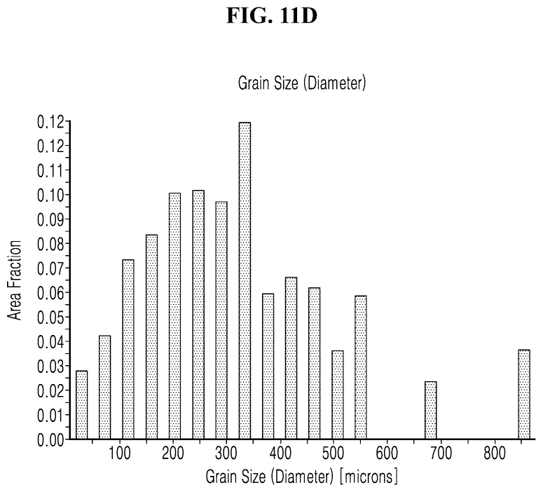

Meanwhile, the grain distribution and size were quantified from the EBSD results. FIG. 11A illustrates the grain distribution of the base material of Example 1. FIG. 11B illustrates the grain distribution of the bending part of Example 1. FIG. 11C illustrates the grain distribution of the base material of Example 2. FIG. 11D illustrates the grain distribution of the bending part of Example 2.

Referring to FIG. 11A, it was confirmed that the average grain size of the base material of Example 1 is 107 μm. Referring to FIG. 11B, it was confirmed that the average grain size of the bending part of Example 1 is 91 μm. Referring to FIG. 11C, it was confirmed that the average grain size of the base material of Example 2 is 300 μm. Referring to FIG. 11D, it was confirmed that the average grain size of the bending part of Example 2 is 320 μm. According to the above results, it may be seen that the grain size of Example 1 is significantly smaller than that of Example 2. In other words, in the case of materials with a large grain size, the orange peel phenomenon appears during the bending molding.

### Experimental Example 5: Tensile Evaluation after Heat Treatment

Additional heat treatment was performed on the trunk lid hinge arm manufactured according to Examples 1 and 2. The additional heat treatment was performed at a temperature of 180° C. for 8 hours. The yield strength, tensile strength, and elongation of the heat-treated trunk lid hinge arm were evaluated. The yield strength, tensile strength, and elongation were measured according to KS B 0802.

The evaluation results are as shown in Table 5 below.

TABLE 5

| | | | Tensile Evaluation | | |
|---|---|---|---|---|---|
| | | | Yield | Tensile | |
| | | | Strength | Strength | Elongation |
| Division | Thickness (mm) | | (MPa) | (MPa) | (%) |
| Example | Vertical Thickness | 7.00 | 220.8 | 251.9 | 16.0 |
| 1 | (t1) | 7.00 | 220.8 | 251.9 | 15.8 |
| | Horizontal | 2.59 | 221.2 | 249.3 | 13.0 |
| | Thickness | 2.56 | 220.3 | 248.8 | 13.1 |
| | (t2) | | | | |
| Example | Vertical Thickness | 7.00 | 216.5 | 257.2 | 15.3 |
| 2 | (t1) | 7.00 | 217.5 | 256.8 | 14.8 |
| | Horizontal | 2.59 | 221.5 | 254.8 | 11.9 |
| | Thickness | 2.56 | 224.0 | 255.8 | 11.1 |
| | (t2) | | | | |

Referring to Table 5, the yield strength and tensile strength of Example 1 showed similar values to Example 2 with no significant difference. That is, as confirmed in Experimental Example 1 above, it was confirmed that the yield strength and tensile strength of Example 2 were higher than those of Example 1, but the mechanical properties of the two examples showed similar values after the heat treatment.

According to one embodiment of the present disclosure, the processing apparatus of a trunk lid hinge arm can process the bending part formed on the trunk lid hinge arm without deformation due to depression. In addition, the processing apparatus of a trunk lid hinge arm can suppress excessive deformation during the processing of the trunk lid hinge arm. The processing apparatus of a trunk lid hinge arm can prevent the dimension dissatisfaction, depression, surface wrinkling, or orange peel of the trunk lid hinge arm that occur due to the excessive deformation.

According to one embodiment of the present disclosure, the processing method of a trunk lid hinge arm can reduce the weight of the finally manufactured trunk lid hinge arm by using an aluminum material. The processing method of a trunk lid hinge arm can provide the trunk lid hinge arm with improved yield strength, tensile strength, elongation, and formability. The processing method of a trunk lid hinge arm can suppress the excessive deformation during the bending. The processing method of a trunk lid hinge arm can prevent the dimension dissatisfaction, depression, surface wrinkling, or orange peel of the trunk lid hinge arm that occur due to the excessive deformation.

According to one embodiment of the present disclosure, the trunk lid hinge arm can reduce the weight by comprising the aluminum alloy. The trunk lid hinge arm can have improved quality by preventing the wrinkles or orange peel from occurring on the surface. The trunk lid hinge arm can have improved yield strength, tensile strength, elongation, and formability.

The effects of the present disclosure are not limited to those mentioned above, and other effects not mentioned can be clearly understood by those skilled in the art from the following description.

Hereinabove, embodiments of the present disclosure have been described with drawings. This is illustrative, and the present disclosure is not limited to the contents of the above-described embodiments and drawings.

It is obvious to those skilled in the art that the present disclosure can be modified within the scope of the disclosed technical idea. The described embodiments should be viewed as part of the present disclosure, and the scope of the present disclosure should not be limited only through the described embodiments.

The scope of the present disclosure should be judged by the technical idea described in the claims. In addition, even if the actions or effects according to the configuration are not explicitly described while describing the embodiments of the present disclosure, it is obvious that the actions or effects that are predictable by the configuration should be recognized as the present disclosure.

1. A processing apparatus of a trunk lid hinge arm, the apparatus comprising:
a mandrel body extending in a longitudinal direction of the trunk lid, and configured to be insertable into an internal space of an extruded material; and
a mandrel core fastened to a front end of the mandrel body;
wherein at least one surface of the mandrel core has a radius of curvature.

2. The processing apparatus of claim 1, wherein the mandrel core comprises:
a molded surface corresponding to a front surface of the mandrel core;
a side surface extending in a longitudinal direction of the mandrel core; and
an edge surface between the molded surface and the side surface;
wherein the molded surface and the edge surface have the radius of curvature.

3. The processing apparatus of claim 2, wherein the radius of curvature (R value) of the molded surface is 50R to 70R.

4. The processing apparatus of claim 2, wherein the radius of curvature (R value) of the edge surface is 0.5R to 3R.

5. A processing method of a trunk lid hinge arm, the method comprising:
preparing aluminum extruded material;
inserting a processing apparatus into an internal space of the extruded material;
rotating the extruded material; and
extracting the processing apparatus.

6. The processing method of claim 5, wherein the processing apparatus comprises:
a mandrel body extending in a longitudinal direction of the trunk lid, and configured to be insertable into an internal space of an extruded material; and
a mandrel core fastened to a front end of the mandrel body;
wherein at least one surface of the mandrel core has a radius of curvature.

7. The processing method of claim 6, wherein the mandrel core comprises:
a molded surface corresponding to a front surface of the mandrel core;
a side surface extending in a longitudinal direction of the mandrel core; and
an edge surface between the molded surface and the side surface;
wherein the molded surface and the edge surface have the radius of curvature.

8. The processing method of claim 7, wherein the radius of curvature (R value) of the molded surface is 50R to 70R.

9. The processing method of claim 7, wherein the radius of curvature (R value) of the edge surface is 0.5R to 3R.

10. The processing method of claim 5, wherein the aluminum extruded material comprises an Al—Mg—Si alloy.

11. The processing method of claim 5, wherein the aluminum extruded material comprises, with respect to a total composition of the extruded material, 0.009 to 0.089 wt % of chromium (Cr), 0.030 to 0.043 wt % of copper (Cu), 0.24 to 0.29 wt % of iron (Fe), 0.47 to 0.55 wt % of magnesium (Mg), 0.039 to 0.10 wt % of manganese (Mn), 0.004 to 0.013 wt % of nickel (Ni), 0.40 to 0.55 wt % of silicon (Si), 0.010 to 0.021 wt % of titanium (Ti), 0.027 to 0.034 wt % of zinc (Zn), and the balance being aluminum (Al).

12. The processing method of claim 5, further comprising:
after extracting the processing apparatus, heat treating the extruded material.

13. A trunk lid hinge arm comprising an aluminum alloy and at least one bending part.

14. The trunk lid hinge arm of claim 13, wherein an average size of grains of the aluminum alloy is 80 μm to 120 μm.

15. The trunk lid hinge arm of claim 13, wherein the aluminum alloy is an Al—Mg—Si alloy.

16. The trunk lid hinge arm of claim 13, wherein the aluminum alloy comprises, with respect to a total composition of the aluminum alloy, 0.009 to 0.089 wt % of chromium (Cr), 0.030 to 0.043 wt % of copper (Cu), 0.24 to 0.29 wt % of iron (Fe), 0.47 to 0.55 wt % of magnesium (Mg), 0.039 to 0.10 wt % of manganese (Mn), 0.004 to 0.013 wt % of nickel (Ni), 0.40 to 0.55 wt % of silicon (Si), 0.010 to 0.021 wt % of titanium (Ti), 0.027 to 0.034 wt % of zinc (Zn), and the balance being aluminum (Al).
